(19) United States
(12) Patent Application Publication
(10) Pub. No.: US 2005/0288820 A1
(43) Pub. Date: Dec. 29, 2005

(54) Novel method to enhance the computer using and online surfing/shopping experience and methods to implement it

(76) Inventors: Yongan Wu, San Jose, CA (US); Fang Zhao, San Jose, CA (US)

Correspondence Address: YONGAN WU, 1419 MARIA WAY, SAN JOSE, CA, 95117, US

(21) Appl. No.: 11/142,493

(22) Filed: Jun. 2, 2005

Related U.S. Application Data
(60) Provisional application No. 60/577,824, filed on Jun. 8, 2004.

(51) Int. Cl. G05B 15/00

(52) U.S. Cl. 700/264

(57) ABSTRACT

A novel virtual attendant between an intelligent device and the human being is provided. The said virtual attendant(s) talk, point to items, answer questions, act as a guide, have face emotions, have specific spoken and/or un-spoken body languages, have specific voices and tones, moves, perform stunts, play games, sing and/or dance, or any combination of the above properties. The said virtual attendant can be the image or animation of the human user's friend(s), family member(s), pet(s), favorite star(s), lover(s), or favorite figure(s)/character(s). The intelligent device(s) can be computers, home based devices, office based devices, car based devices, portable devices, and any other devices. The virtual attendant can act as the interface between the device and the human users, perform many functions from answer questions and provide guidance and services.

### BACKGROUND OF THE INVENTION

This invention relates to the interface between a computer or web application device to the human users.

The computer and web interfaces have enhanced greatly in the past several decades. It has changed from the initial card punching to keyboard text input and monitor test output. Apple and Microsoft then revolutionized the interface with windows, which greatly improve the users' efficiency and convenience. Later Audio speaker and video card also greatly boosted the interface efficiency. In current computer or web application interface, the machine, whether it's a computer, a hand held PDA, or a cell phone, or other devices, has evolved into a very complicated, smart machine which can communicate with human users very efficiently.

A typical computer system is shown in FIG. 1. Computer 1 communicate with its user with monitor 2 for output, and keyboard 3 and mouse 4 for input in most of the cases. As shown in FIG. 2, computer can ask a question 5 in text on monitor screen 2. Then user can answer the question in answer 6 with keyboard 3 to input. For another Question 7, user can answer by selection answer A or B using the mouse 4 to input.

However, it is still more like a machine, with most of the interaction still in the forms of text words, various forms and blanks to be filled. Computer interactions, as well as online experiences like shopping or surfing, still more like interaction with machines than human being communities. It is desired to have a more advanced, human friendly interactions. This is especially important for all those users, which are not technology-savvy but ordinary people. It is desired to have an interface, which is friendlier to the general public to really enhance the ordinary people's experience, to improve the efficiency and productivity when using the computers and/or online interactions.

### SUMMARY OF THE INVENTION

This and other objects of the invention are accomplished in accordance with the principles of the present invention by providing an innovative interface between the computers and the human users. This interaction can be designed to be through a human-like virtual interface. The input can still be through keyboard, mouse, or other forms like voice, video, or moves. However, instead of getting this input into a cold machine or net wire, we can design a virtual interface in front of the machine. An attendant can be introduced as the virtual interface. All or part of the inputs can be applied to this virtual attendant, which will in turn carry out the tasks and/or answer inquiries. The virtual attendant can be a person's image, or a pet, or a cartoon characters. It can be customized with input from the users, like the scanned in images of his favorite pets, sports or movie stars, his role models, or anything/anyone he prefers, like even the governors or presidents. Various moves, stunts, words, languages, music, singing or dancing can be applied to the virtual attendant, input or selected by the end users. The information about the attendant can be stored in local or remote sites, or both.

This attendant can be used by various computer programs, or by various online applications. For example, online shopping/auction/search engine sites can use such attendants to serve their customers. The attendant will make the experience more human/community-neighbor like. With their favorite/their own pets or other characters as the servants, satisfying their needs and answering their questions, they will have a much pleasant encounter with the web, especially for the less technical savvy ones.

### BRIEF DESCRIPTION OF THE DRAWINGS

FIG. 1 is a schematic diagram of an illustrative traditional computer system, using monitor screen, keyboard, and mouse as the interface to the machine.

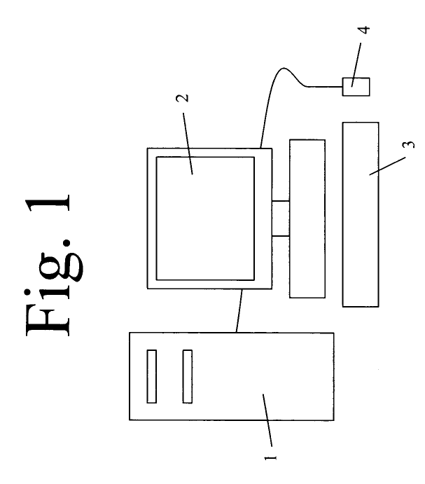

FIG. 2 is a schematic diagram of an illustrative traditional online application program, use text forms, text questions directly on display monitors as the interface to the online program software.

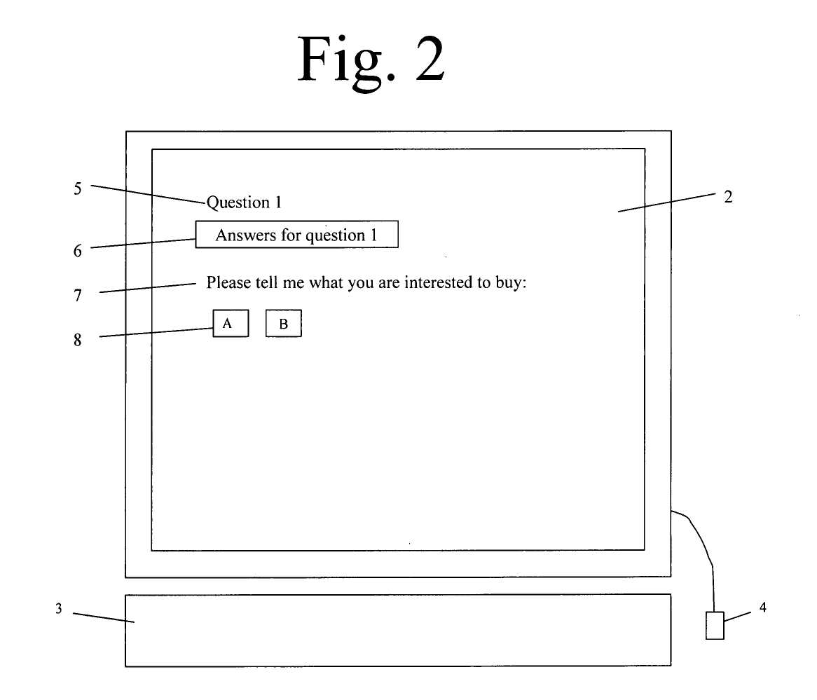

FIG. 3 is schematic diagram of an illustrative virtual attendant as the main or part of the interface. A user's favorite character or person can be served as the virtual attendant.

FIG. 4 is another schematic diagram of an illustrative virtual attendant as the main or part of the interface. A pet or cartoon can be used to be the virtual attendant.

FIG. 5 is a flow chart of means to implement the virtual attendant. The user can select, upload, and modify the behavior of the virtual attendant.

FIG. 6 is a flow chart of means to implement the user command transformation into computer recognized command.

### DETAILED DESCRIPTION OF THE PREFERRED EMBODIMENTS

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

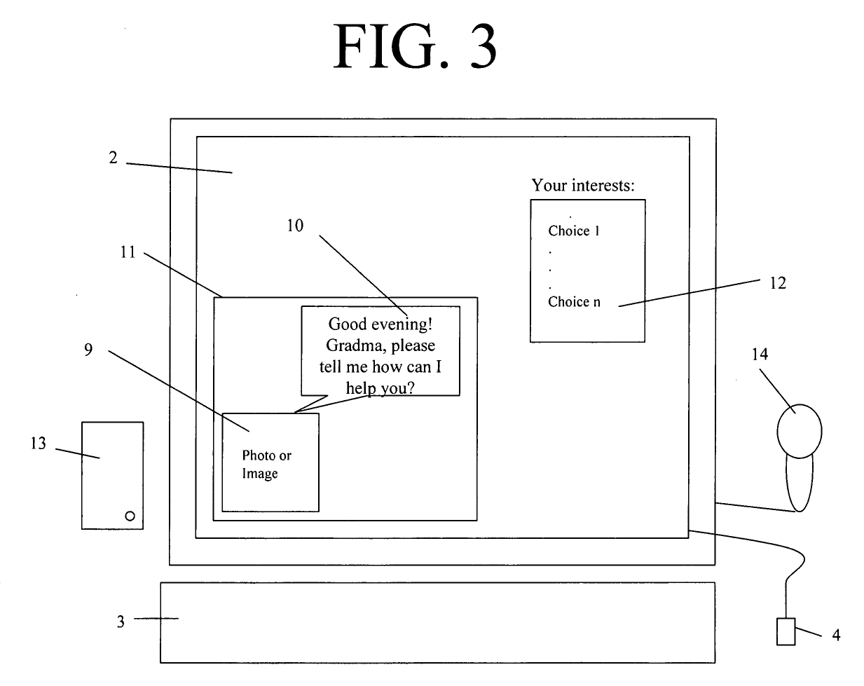

An illustrative new computer interface for human interaction can be shown in FIG. 3. A virtual attendant 9 can be used as a user interface between the computer and the user. It can show up at a specific location on the screen, for example, in a boxed area 11, or it can be on top of other displayed areas. It can be transparent or half transparent. It can communicate with the user using dialogue box 10, pictures like drawing 12, or use sound input and output like the speaker 13 and the microphone 14. The virtual attendant can be selected or uploaded by user, such as a photo of his relatives and desired persons, like grandson, daughter, son, dad, mom, grandparent, spouse, lover, boyfriend, girlfriend, friends, boss, secretary, movie star(s), sport star(s), singer(s), teacher(s), personal trainer, coach, professional helper, etc. It can be either a single person or group of persons. The virtual attendant interface can be for a computer, a internet site, a car control center, a digital home control center, a cell phone, a personal aid like Palm or laptop computer, a mini-computer, a game machine like Xbox, Nintendo, Play Station, etc.

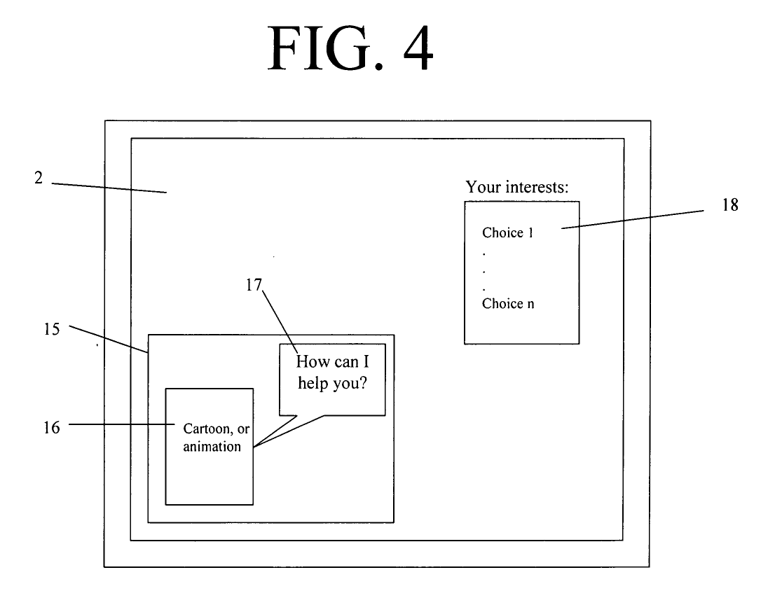

An illustrative new computer interface for human interaction can be shown in FIG. 4. A virtual attendant 16 can be used as a user interface between the computer and the user. This virtual attendant can be a user specified or designed characters, like cartoon characters or other specific items the user likes. The character can change regularly based on the computer/website setting or the user's selection and programming.

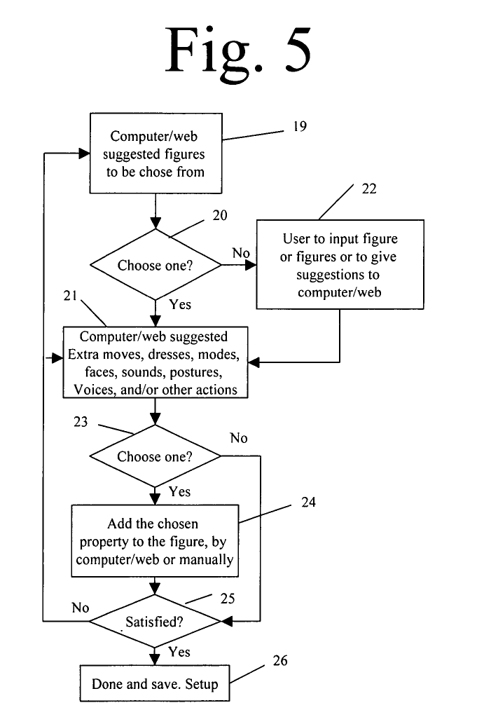

A method to setup the virtual attendant can be illustrated in FIG. 5. At the beginning of the process, the computer/web can suggest figures to be chosen from in step 19, in the next step 20, user can select to choose one or input one, if he/she design to use the virtual attendant service. If the user chooses to input his design, in step 22 he/she can input figure or figures or just to give suggestions to computer/web, so his wishes can be designed into the virtual attendant's characteristics, like face, body, dress, action, figure, sound, and voices. At step 21, computer/web can further suggest extra moves, dresses, modes, faces, sounds, postures, voices, and/or other actions to the virtual attendant. The user can choose certain characteristics he/she like for the virtual attendant, and in step 24 the computer/web can give the chosen properties to the figure. This process can either be automatically done by the computer/web or be done manually by the service people who are supporting the virtual attendant services. In step 25, if the user is satisfied with his/her setting, he can choose done to save the setup in step 26, for the computer to put the setting into effect, or he can choose not satisfied yet, to go back into the process loop to do more modifications or add/delete some features.

The virtual attendant can act as the center interface between the user and all or part of the other functions/programs. For example, it can remind user to pay attention to their health. Say prayers. Praise the user. Give tips to user. Read stories or jokes to user. Provide various advices, like diet advice, health advice, financial advice, professional advice. Provide various information, like stock and/or other financial information, weather, temperature, road traffic information, news, sports update, and/or any other information.

The virtual attendant can be the only or one of the operating system the user sees, even though itself can still be or not be resided on top of another operating system internally.

The virtual attendant act as a personal guide or trainer. It can offer self-help courses on diet, exercise, stress control, self-esteem promotion, relaxation, Yoga, Qigong, martial arts, and/or other tips and lessons. The user can select specific courses he/she wants to take and have it provided every time. It can also be selected by others, like by the employer, or friends, or professionals like doctors, or relatives like moms.

The virtual attendant provides commercials advertisement, or business news to the user, with or without the permission of the user. An incentive can be provided to the user for this function to be activated.

The virtual attendant can provide commercials advertisement, incentives, or business news to the user, with or without the permission of the user. It can play games with the user, either online or local games. It can also act as the guide or teacher to the user, explains and shows a new operating system, new software, a new exercise, a class, and/or an online course to the user. It can also be used to answer specific questions, about the product, the information, and/or the courses. It can also arrange model shows, specific combinations, price information, size information, warranty information, comparison, and/or other information the user desire. It can be prepared in advance for the server, on have input from in-situ online help from the server or a third company.

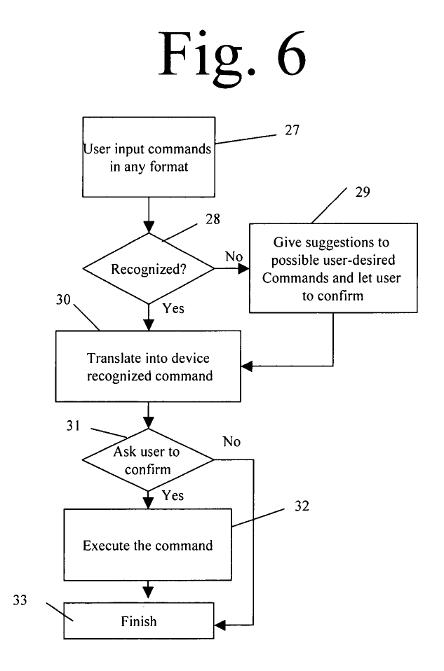

As illustrated in FIG. 6, the virtual attendant can utilize to translate general human language like command 27 to computer recognized command 30. If could not find a corresponding computer recognized command as in step 28, it can recommends sets of commands in step 29 that are liked to be the user desired command, to let the user to choose. Then it can ask the user to confirm the command in step 31, and then execute the transformed command in step 32. It can also skip the user confirmation step 31 to jump to execution step 32, before finish the process in step 33.

1. An intelligent device/software with a virtual attendant serves as the whole or part of the interface between the human user and the device/software. The said virtual attendant(s) talk, point to items, answer questions, act as a guide, have face emotions, have specific spoken and/or un-spoken body languages, have specific voices and tones, moves, perform stunts, play games, sing and/or dance, or any combination of the above properties.

2. The said intelligent device defined in claim 1 is a computer.

3. The said intelligent software defined in claim 1 is a computer program, including an online program.

4. The said intelligent software defined in claim 1 is a shopping site, an auction site, a search site, an educational site, an information site, a gambling site, a game site, a company web page, a government web page, a theater website, a religious website, a pornographic website, a no-profit website, a retail website, a car dealer website, a jewelry website, an advertisement website, a service website, an online music website, an online financial website, or any other online programs.

5. The said intelligent device defined in claim 1 is a portable device, including cell phone, personal digital aid, CD player, walkman, mp3 player, music player, game player, language translator device, digital dictionary, digital map, navigator, and GPS location device, or any other portable devices.

6. The said intelligent device defined in claim 1 is a home based or a car equipped device, like TV, DVD player, stereo, digital music player, or a digital home center, or car entertainment center, or a car video system, or a car navigation system, or any other devices inside a home or car.

7. The said intelligent device defined in claim 1 is an office display system, including projector.

8. The said intelligent device defined in claim 1 is a game player, including Xbox, Nintendo, and Play Station, etc.

9. The virtual attendant is suggested by the intelligent device or its server, or it is selected by the user from choices provided by the server, or it can be input by the user.

10. The said virtual attendant defined in claim 9 is a simulation of a known figure of the user, including the user's friend, relative, including grandparent, dad, mom, brother, sister, son, daughter, uncle, aunt, nephew, niece, god son, god daughter, grandson, grand daughter, the user's preferred movie star, sports star, cheerleader, model, singer, dancer, and/or entertainer, a public figure like the major, governor, president, religious figure, or any other figures the user likes.

11. The said virtual attendant defined in claim 9 is input by the user. It is a user's pet or pets, like a dog, a cat, a bird, a fish, a lizard, a mouse, a snake, a rabbit, a dinosaur, a turtle, a tiger, a deer, a lion, a raccoon, a leopard, or any other animal or animals, or any combination of them.

12. The virtual attendant defined in claim 9 is a professional figure, like a doctor, a nurse, a policeman, a firefighter, a gardener, a pastor, an officer, a military figure, a professor, a teacher, a chef, a writer, a lawyer, or any other professional figures.

13. The said virtual attendant defined in claim 9 is input by the user, by input of digital photo(s) or picture(s), or computer generated drawing(s), or manual drawings, or video(s).

14. The said virtual attendant defined in claim 9 talks to the user using language-speaking technology through a speaker or headphone, and/or listen to the user through a microphone.

15. The said virtual attendant defined in claim 9s talks to the user using a balloon text box or any other on screen display format.

16. The said virtual attendant defined in claim 9 has animated actions or stunts, or words, or voices, or tunes, or faces, or emotions, or languages, including verbal and/or no verbal body languages. The said actions is added by the server, or selected by the user from the provided choices, or suggested by the user.

17. The said virtual attendant defined in claim 9 is a real character, a real life model inside, on top, or beside the device, to have real interactions with the user.

18. The said virtual attendant defined in claim 9 resides inside a specifically defined area on the screen. This area is specified for this virtual attendant only. This area can be moved by the user, to be on different locations on the screen

19. The said virtual attendant defined in claim 9 can be transparent or semi-transparent. This allows the users to see through the attendant for any other information, which are displayed in the shared areas.

20. The virtual attendant defined in claim 9 can change its size and/or shape, to best use the space on the screen.

21. The virtual attendant defined in claim 9 displayed on a separated screen, which is different from the main displays.

22. The virtual attendant defined in claim 9 can have other properties, like smells a different flavor when it appears, using pre-stored scent flavors accompany the device, or smokes, fog, or other effects.

23. The said virtual attendant defined in claim 9 is resided on top of MS DOS, windows, Unix, Linux, Mac OS, or any other operating systems.

24. The virtual attendant acts as the interface between the user and all or part of the other functions/programs on the intelligent device.

25. The said virtual attendant defined in claim 24 is the first or can be switched to be the first interface a user see when starting the devices like computer, cell phone, handheld PDA, or other systems.

26. The said virtual attendant interface defined in claim 24 use a specific general rule or format Everyone can have access to it to put better use to it according to the specifically designed rules.

27. The said virtual attendant defined in claim 24 acts as a personal guide or trainer. It offers self-help courses on diet, exercise, stress control, self-esteem promotion, relaxation, Yoga, Qigong, martial arts, and/or other tips and lessons.

28. The said virtual attendant defined in claim 24 monitors the said course progress. It provides explanations, receives results input from user, provides extra help wherever needed, sends feedbacks to various sources, like the professionals (doctors, teachers, parents, or to the user herself/himself, etc.), and then adjust the course accordingly, or perform any combination of these tasks.

29. The said virtual attendant defined in claim 24 is a personal helper. It monitors the device use and reminds for a break or provides a game, or news, or traffic, or joke, or stock market update, or story, or any combination of them.

30. The said virtual attendant defined in claim 24 provides email, voice mail, video mail information, and/or reminder(s) to the user.

31. The said virtual attendant defined in claim 24 provides other related information to user, like virus alert, hacker alert, program update alert, sales alert, and/or any other alerts or information.

32. The said virtual attendant defined in claim 24 provides commercials advertisement, incentives, or business news to the user, with or without the permission of the user.

33. The said virtual attendant defined in claim 24 is utilized to play games with the user, either online or local games.

34. The said virtual attendant defined in claim 24 acts as the guide or teacher to the user, explains and shows a new operating system, a new software, a new exercise, a class, an online course to the user.

35. The said virtual attendant defined in claim 24 answers specific questions, about a product, the information, and/or the courses, to arrange model shows, specific combinations, price information, size information, warranty information, comparison, and/or other information the user desire, or any combination of these.

36. The said virtual attendant defined in claim 24 is utilized to translate general human language like command to computer-recognized command.

37. The said virtual attendant defined in claim 24, if could not find a corresponding computer recognized command, recommends sets of commands that are liked to be the user desired command, to let the user to choose from.

38. The said virtual attendant defined in claim 24 executes the transformed command, with or without the confirmation from the user.
